(19) United States
(12) Patent Application Publication
(10) Pub. No.: US 2008/0259207 A1
(43) Pub. Date: Oct. 23, 2008

(54) Motion Compensated De-Interlacing with Film Mode Adaptation

(75) Inventors: Gerard De Haan, Eindhoven (NL); Calina Ciuhu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,577

(22) PCT Filed: Jan. 24, 2005
(86) PCT No.: PCT/IB05/50268

§ 371 Date: Jul. 31, 2006

(30) Foreign Application Priority Data
Feb. 4, 2004 (EP) 04100410.2

(51) Int. Cl. H04N 7/01

(52) U.S. Cl. 348/452; 348/E07.003

(57) ABSTRACT

The invention relates to a method for de-interlacing a hybrid video sequence using at least one estimated motion vector for interpolating pixels. Field for petition patents, typically occurring in film originated video material, disturb the function of de-interlacing algorithm designed to convert interlaced video single into progressively scanned video. Therefore a mode decision has to be applied for local adaptation to the film/video mode, which is possible by defining values for a first motion vector and a second motion vector, calculating at least one first pixel using at least one pixel of previous image and one first motion vector, calculating at least one second pixel using at least one pixel of a next image and one second motion vector, calculating a reliability of said first and the second motion vector by comparing at least said first pixel with at least said second pixel the first and said second motion vectors being pre-defined for said calculation of reliability, and estimation an actual value for a motion vector, which turned out to be most reliable for de-interlacing said image.

The invention relates to a method, display device, and computer programme for de-interlacing a hybrid video sequence using at least one estimated motion vector for interpolating pixels.

De-interlacing is the primary resolution determination of high-end video display systems to which important emerging non-linear scaling techniques can only add finer detail. With the advent of new technologies like LCD and PDP, the limitation in the image resolution is no longer in the display device itself, but rather in the source or transmission system. At the same time these displays require a progressively scanned video input. Therefore, high quality de-interlacing is an important pre-requisite for superior image quality in such display devices.

A first step to de-interlacing is known from P. Delonge, et al., “Improved Interpolation, Motion Estimation and Compensation for Interlaced Pictures”, IEEE Tr. on Im. Proc., Vol. 3, no. 5, September 1994, pp 482-491. In order to obtain progressive scan from an interlaced sequence, de-interlacing algorithm are applied. The interlaced video sequence, which is the input for the de-interlacing algorithm, is a succession of fields with alternating even and odd phases.

Delonge proposed to just use vertical interpolators and thus use interpolation only in the y-direction.

Within this approach, a generalised sampling theorem GST filter is proposed. When using a first-order linear interpolator, a GST-filter has three taps. The interpolator uses two neighbouring pixels on the frame grid. The derivation of the filter coefficients is done by shifting the samples from the previous temporal frame to the current temporal frame. As such, the region of linearity for a first-order linear interpolator starts at the position of the motion compensated sample. When centering the region of linearity to the centre of the distance between the nearest original and motion compensated sample, the resulting GST-filters may have four taps. Thus, the robustness of the GST-filter is increased. This is also known from E. B. Bellers and G. de Haan, “De-interlacing: a key technology for scan rate conversion”, Elsevier Science book series “Advances in Image Communications”, vol. 9, 2000.

The combination of the horizontal interpolation with the GST vertical interpolation in a 2-D inseparable GST-filter results in a more robust interpolator. As video signals are functions of time and two spatial directions, the de-interlacing which treats both spatial directions, results in a better interpolation. The image quality is improved. The distribution of pixels used in the interpolation is more compact than in the vertical only interpolation. That means pixels used for interpolation are located spatially closer to the interpolated pixels. The area pixels are recruited from for interpolation may be smaller. The price-performance ratio of the interpolator is improved by using a GST-based de-interlacing using both horizontally and vertically neighbouring pixels.

A motion vector may be derived from motion components of pixels within the video signal. The motion vector represents the direction of motion of pixels within the video image. A current field of input pixels may be a set of pixels, which are temporal currently displayed or received within the video signal. A weighted sum of input pixels may be acquired by weighting the luminance or chrominance values of the input pixels according to interpolation parameters.

Performing interpolation in the horizontal direction may lead, in combination with vertical GST-filter interpolation, to a 10-taps filter. This may be referred to as a 1-D GST, 4-taps interpolator, the 4 referring to the vertical GST-filter only. The region of linearity, as described above, may be defined for vertical and horizontal interpolation by a 2-D region of linearity. Mathematically, this may be done by finding a reciprocal lattice of the frequency spectrum, which can be formulated with a simple equation

f̅x̅=1

where f̅=(fₕ,fᵥ) is the frequency in the x̅=(x,y) direction. The region of linearity is a square which has the diagonal equal to one pixel size. In the 2-D situation, the position of the lattice may be freely shifted in the horizontal direction. The centres of triangular-wave interpolators may be at the positions x+p+δₓ in the horizontal direction, with p an arbitrary integer. By shifting the 2-D region of linearity, the aperture of the GST-filter in the horizontal direction may be increased. By shifting the vertical coordinate of the centre of the triangular-wave interpolators at the position y+m, an interpolator with 5-taps may be realised.

FIG. 2 depicts a reciprocal lattice 12 in the frequency domain and the corresponding lattice in the spatial domain, respectively. The lattice 12 defines the region of linearity which is now a parallelogram. A linear relation is established between pixels separated by a distance | x̅| in the x̅ direction. Further, the triangular interpolator used in the 1-dimensional interpolator may take the shape of a pyramidal interpolator. Shifting the region of linearity in the vertical or horizontal direction leads to different numbers of filter taps. In particular, if the pyramidal interpolators are centred at position (x+p,y), with p an arbitrary integer the 1-D case may result.

In general, it is possible to distinguish three different modes of video among the existing video material. A so-called 50 Hz film mode comprises pairs of two consecutive fields originating from the same image. This film mode is also called 2-2 pull-down mode. This mode often occurs, when a 25 pictures/second film is broadcasted for 50 Hz television. If it is known, which fields belong to the same image, the de-interlacing reduces to field insertion.

In countries with 60 Hz power supply, a film is run at 24 pictured/second. In such a case a so-called 3-2 pull-down mode is required to broadcast film for television. In such a case, successive single film images are repeated in three fields and two fields, respectively, resulting in a ratio of 60/24-2.5 on the average. Again, a field insertion can be applied for de-interlacing, if the repetition pattern is known.

If any two consecutive fields of a film belong to different images, the sequence is in a video mode, and de-interlacing has to be applied with a particular algorithm in order to obtain a progressive sequence.

It is also known that a combination of film mode and video mode appears within a sequence. In such a so-called hybrid mode different de-interlacing methods have to be applied. In a hybrid mode, some regions of the sequence belong to a video mode, while the complementary regions are in film mode. If field insertion is applied for de-interlacing a hybrid sequence, the resulting sequence exhibits so-called teeth artefacts in the video-mode regions. On the other hand, if a video de-interlacing algorithm is applied, it introduces undesired artefacts, such as flickering, in the film-mode regions.

In U.S. Pat. No. 6,340,990, de-interlacing hybrid sequences is described. A method is disclosed, which proposes to use multiple motion detectors to discriminate between the various modes and adapt the de-interlacing, accordingly. Since the proposed method does not use motion compensation, the results in moving video parts are poor.

Therefore, an object of the invention is to provide hybrid video sequence de-interlacing, capable of providing high quality results. Another object of the invention is to provide a de-interlacing for hybrid video sequences, accounting for video mode and movements in the scene.

These and other objects of the invention are solved by a method for de-interlacing a hybrid video sequence using at least one estimated motion vector for interpolating pixels with the steps of defining values for a first motion vector and a second motion vector, calculating at least one first pixel using at least one pixel of a previous image and said first motion vector, calculating at least said second pixel using at least one pixel of a next image and one second motion vector, calculating a reliability of said first and said second motion vector by comparing at least said first pixel with at least said second pixel, said first and said second motion vectors being pre-defined for said calculation of reliability, and estimating an actual value for a motion vector which turned out to be most reliable for de-interlacing said image.

One advantage of the inventive method is that different modes may be detected, and de-interlacing may be adapted to the respective mode. A de-interlacer may be provided with an inherent film/video mode adaptation. Also, motion compensation may be applied for de-interlacing. It has been found that for motion compensated de-interlacing, the relation between the motion vectors with respect to the previous field and the next field have to be accounted for. For a block of pixels, the video mode of a sequence may be calculated by comparing pixels calculated with motion vectors from a previous field, and a next field and comparing these pixels. Depending on the mode of a block of pixels, different motion vectors provide different results and reliability may be calculated.

If a sequence is in video mode, the absolute values of motion vectors of a previous field and a next field are equal and the motion vectors are inverted, when assuming a linear motion over two field periods. This means v̅n=− v̅p. If the sequence is in film mode, then either v̅n= 0̅ and v̅p≠ 0̅, or v̅n≠ 0̅ and v̅p= 0̅. Eventually, if the sequence comprises a non-moving object, or if the sequence is in one of the 3-2 pull-down phases, then v̅n= v̅p= 0̅. Therefore, motion vectors may be pre-defined to account for different modes. With these pre-defined motion vectors, pixels may be calculated from a previous and a next image. By comparing these pixels, it may be found for which of these pre-defined motion vectors the calculated pixels are equal or similar, and for which the calculated pixels differ. For these motion vectors, where the difference between the calculated pixels is smallest, the corresponding mode may be estimated.

The predefined values to derive a first vector and a second vector may be defined from said estimated vector.

As, in theory, the current field can be de-interlaced with the previous field as with the next field, it may be checked for which of the above situations the two de-interlacing results resemble each other most. By building the decision on a block-by-block basis, it is possible to integrate it with a for de-interlacing optimised three field motion estimator.

It may be possible to comprise the mode detection with a motion compensated de-interlacer based on the generalised sampling theorem. Thus, film detection may be optimised for a generalised sampling theorem de-interlacing algorithm. Yet, any other de-interlacing algorithm may be applied.

According to claim 2, and claim 3, a relation between the motion vectors may be applied. In particular the motion vectors may be inverted. By this, the video mode may be detected, as within video mode with linear motion, v̅n=− v̅p. If the motion vectors are related to each other for the pre-defined values, then in video mode the two pixels resemble each other most. For other modes, pre-defining the motion vectors as being related to each other, results in larger differences between the pixels calculated from these motion vectors. The predefined vectors may be −1 and 1, respectively, and the first and second vector may be derived from multiplying the estimated vector with its pre-defined value.

When applying a method according to claim 4, a film mode may be detected, as in film mode at least two consecutive images are a copy of each other and then a motion vector is zero. The other motion vector may have a value different than zero vector. That means that the predefined values may be 1, or 0.

To analyse the mode of a sequence, a method of claim 5 is proposed. By calculating an error criterion for different estimated motion vectors, a mode of a sequence may be detected. Therefore, it may be possible to calculate a first error criteria based on pixels from a current field, pixels from a previous field shifted over said first motion vector and pixels from the next field shifted over a second motion vector. The second motion vector may be the inverse of the first motion vector. Also, a second error criterion may be calculated based on pixels from the current field, pixels from the previous field shifted over said first motion vector and pixels from the next field shifted over said second motion vector, said second motion vector having a value of zero. A third error criteria may also be calculated based on pixels from a current field, pixels from the previous field shifted over said first motion vector having a zero value, and pixels from the next field shifted over said second motion vector. A fourth error criterion may be calculated based on pixels from the current field, pixels from the previous field shifted over said first motion vector with a zero value, and pixels from the next field shifted over said second motion vector with zero value.

If the first error criterion is the minimum, a video mode might be detected, and the interpolated pixel is calculated from pixels in the current field, pixels in the previous field shifted over said first motion-vector and pixels in the next field shifted over the second motion vector, the second motion vector being the inverse of the first motion vector.

If the second error criterion is the minimum, a film mode might be detected, and the interpolated pixel is calculated from pixels in the current field, pixels in the previous field shifted over the first motion vector and pixels in the next field shifted over a zero motion.

In case the third error criterion is the minimum, again a video mode might be detected, and the interpolated pixel is calculated from pixels in the current field, pixels in the previous field shifted over the zero motion vector, and pixels in the next field shifted over the second motion vector.

Eventually, if the fourth error criterion is the minimum, a zero mode might be detected, and the interpolated pixel is calculated from pixels in the current field, pixels in the previous field shifted over a zero motion vector and pixels in the next field shifted over a zero motion vector.

Each error criterion defines a different mode, and may be used for calculating the appropriate interpolated image. Depending on which mode is detected, different motion vectors and different values thereof may be used to de-interlace the image with the best results.

To find the error criteria, a method of claim 6 is proposed. By calculating the absolute sum over a block of pixels, more than one pixel may account for estimating the correct mode.

A method according to claim 7 allows for penalising certain error criteria. By adding a bias to the results, a mode which is detected but is not the majority mode per image, or least expected by some other reasons may be penalised through the respective error criterion. In case the biased error criterion is still the minimum, the appropriate de-interlacing is applied.

According to claim 8, the modes of vectors in the direct neighbouring spatio-temporal environment may be accounted for. If the error criteria calculated for the current block does not coincide with spatio-temporal neighbouring error criteria, it may be penalised adding a bias. Only if this error criterion is still the minimum with this penalty, the appropriate de-interlacing may be applied.

Another aspect of the invention is a display device for displaying a de-interlaced video signal comprising definition means for defining values for a first motion vector and a second motion vector, first calculation means for calculating at least one first pixel using at least one pixel of a previous image and said first motion vector, second calculation means for calculating at least one second pixel using at least one pixel of a next image and said second motion vector, third calculation means for calculating a reliability of said first and said second motion vector by comparing at least said first pixel with at least said second pixel, said first and said second motion vectors being pre-defined for said calculation of reliability, and estimation means for estimating an actual value for a motion vector which turned out to be most reliable for de-interlacing said image.

A further aspect of the invention is a computer programme for de-interlacing a video signal operable to cause a processor to define values for a first motion vector and a second motion vector, calculate at least one first pixel using at least one pixel of a previous image and said first motion vector, calculate at least one second pixel using at least one pixel of a next image and said second motion vector, calculate a reliability of said first and said second motion vector by comparing at least said first pixel with at least said second pixel said first and said second motion vectors being pre-defined for said calculation of reliability, and estimate an actual value for a motion vector which turned out to be most reliable for de-interlacing said image.

These and other aspects on the invention will be apparent from and elucidated with reference to the following figures. In the figures show:

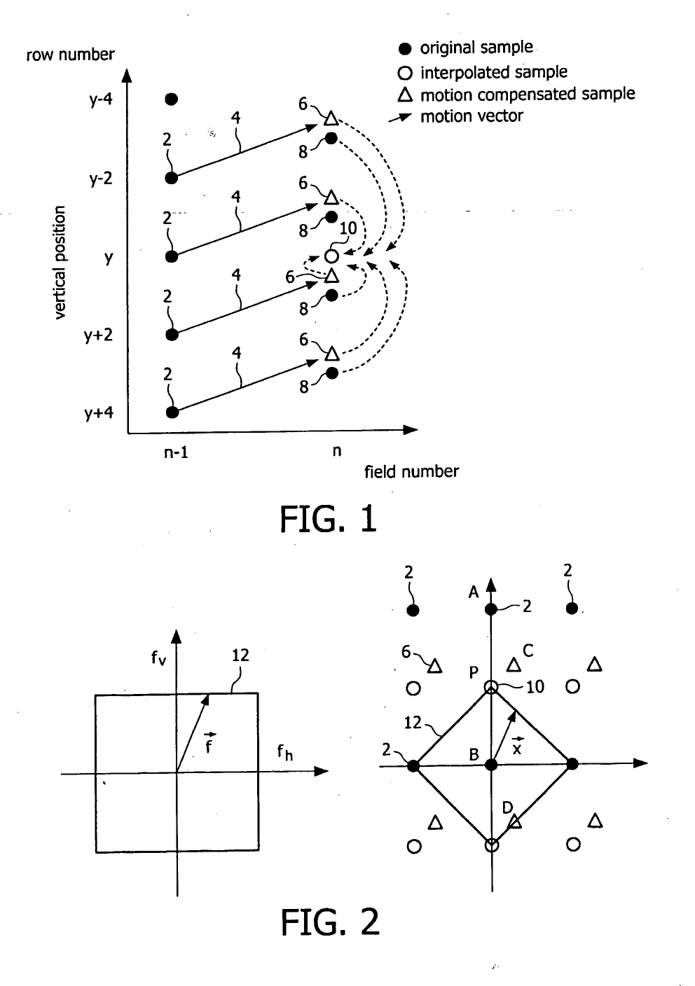

FIG. 1 a GST de-interlacing;

FIG. 2 a region of linearity;

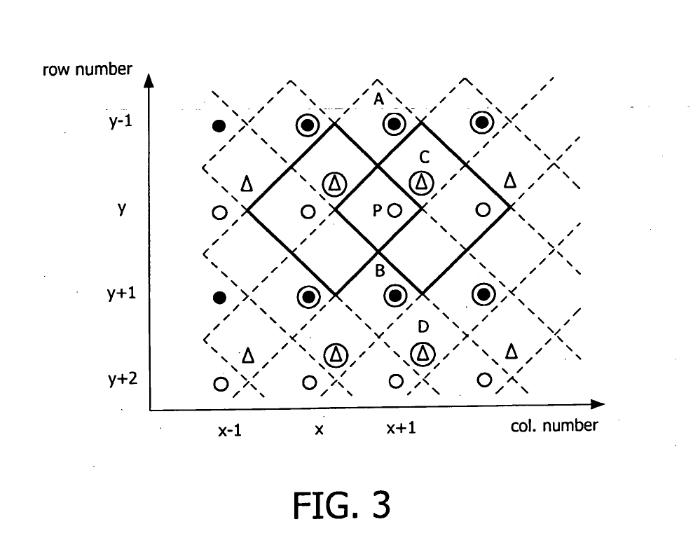

FIG. 3 a grid of regions of linearity for de-interlacing with a GST motion compensated de-interlacing;

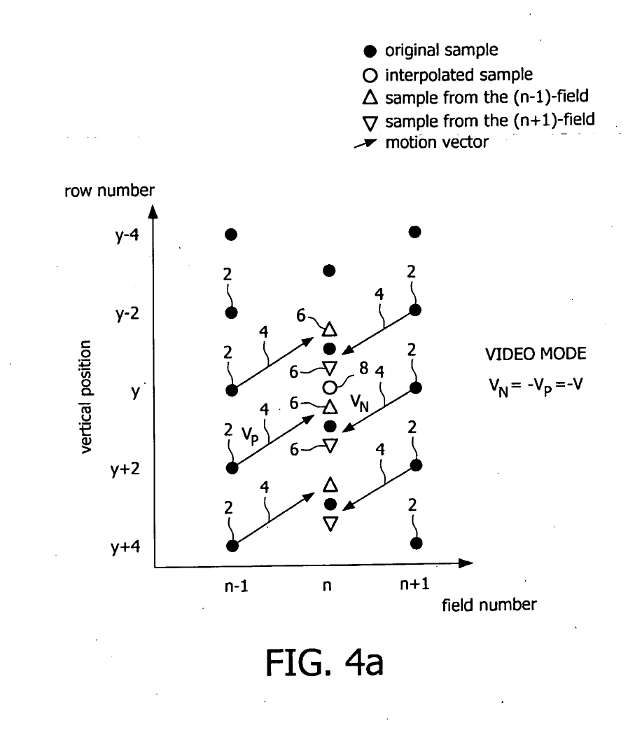

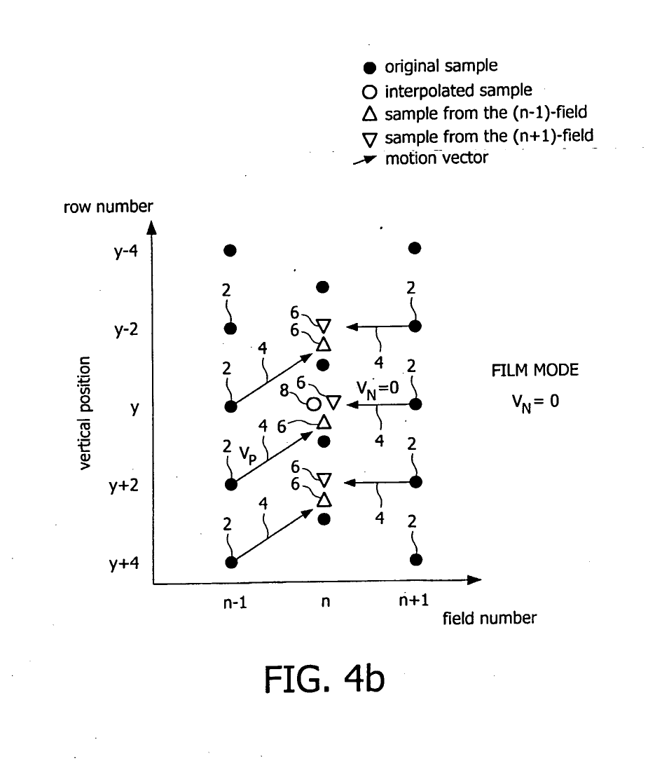

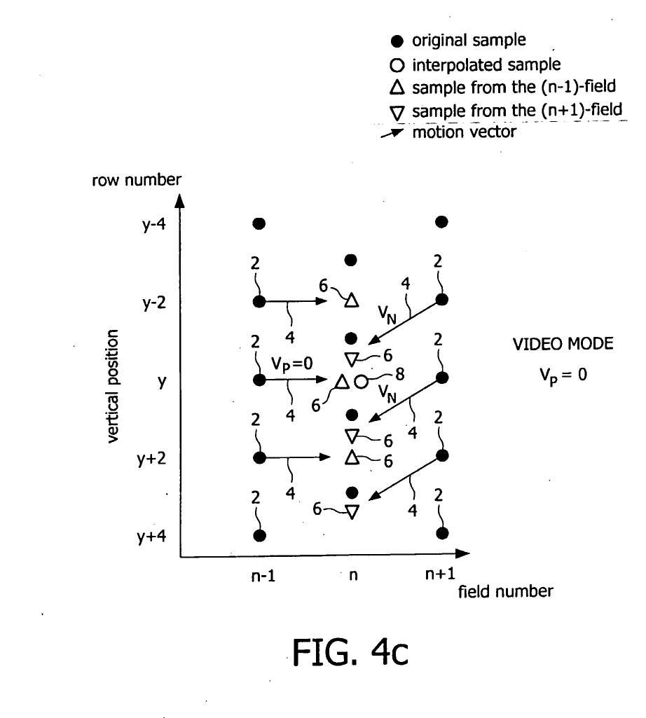

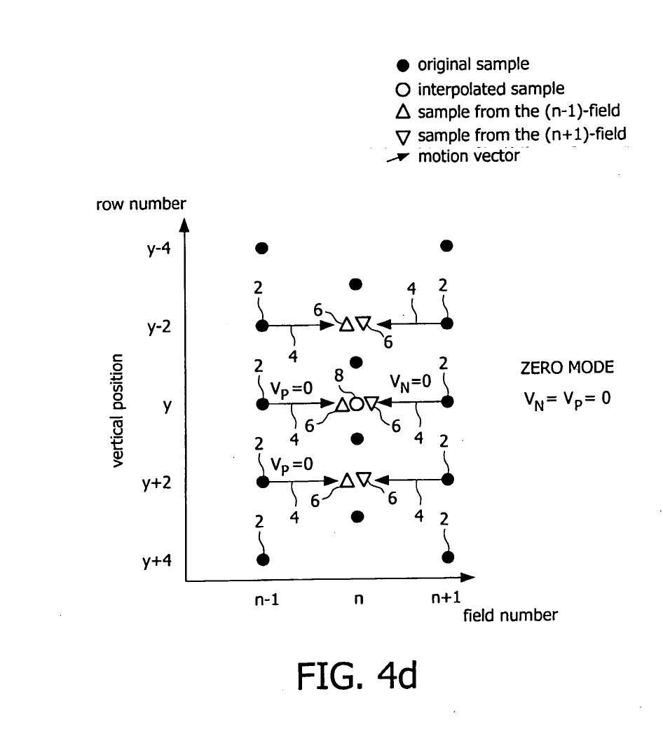

FIG. 4A a video mode;

FIG. 4B a film mode;

FIG. 4C another film mode;

FIG. 4D a zero mode.

One possible de-interlacing method is also known as the general sampling theorem (GST) de-interlacing method. The method is depicted in FIG. 1. FIG. 1 shows a field of pixels 2 in a vertical line on even vertical positions y+4-y−4 in a temporal succession of n−1-n. For de-interlacing, two independent sets of pixel samples are required. The first set of independent pixel samples is created by shifting the pixels 2 from the previous field n−1 over a motion vector 4 towards a current temporal instance n into motion compensated pixel samples 6. The second set of pixels 8 is located on odd vertical lines y+3-y−3. Unless the motion vector 6 is small enough, e.g. unless a so-called “critical velocity” occurs, i.e. a velocity leading to an odd integer pixel displacements between two successive fields of pixels, the pixel samples 6 and the pixels 8 are said to be independent. By weighting the pixel samples 6 and the pixels 8 from the current field the output pixel sample 10 results as a weighted sum (GST-filter) of samples.

Mathematically, the output sample pixel 10 can be described as follows. Using F( x̅,n) for the luminance value of a pixel at position x̅ in image number n, and using Fᵢ for the luminance value of interpolated pixels at the missing line (e.g. the odd line) the output of the GST de-interlacing method is as:

$${F}_{i} ( \vec{x} , n ) = {\sum }_{k} F ( \vec{x} - ( 2 k + 1 ) {\vec{u}}_{y} , n ) {h}_{1} ( k , {δ}_{y} ) + {\sum }_{m} F ( \vec{x} - \vec{e} ( \vec{x} , n ) - 2 m {\vec{u}}_{y} , n - 1 ) {h}_{2} ( m , {δ}_{y} )$$

with h₁ and h₂ defining the GST-filter coefficients. The first term represents the current field n and the second term represents the previous field n−1. The motion vector ē( x̅,n) is defined as:

$$\vec{e} ( \vec{x} , n ) = ( \begin{matrix}{d}_{x} ( \vec{x} , n ) \\ 2 Round ( \frac{{d}_{y} ( \vec{x} , n )}{2} )\end{matrix} )$$

with Round ( ) rounding to the nearest integer value and the vertical motion fraction δ_{y} defined by:

$${δ}_{y} ( \vec{x} , n ) = \vert {d}_{y} ( \vec{x} , n ) - 2 Round ( \frac{{d}_{y} ( \vec{x} , n )}{2} ) \vert$$

The GST-filter, composed of the linear GST-filters h₁ and h₂, depends on the vertical motion fraction di δ_{y}( x̅,n) and on the sub-pixel interpolator type.

When applying a non-separable version of a GST-filter, the region of linearity may be extended in the horizontal direction. The non-separability of such a GST-filter is not a requirement for the inventive method. However, a larger horizontal aperture increases the robustness of the method. In addition, a non-separability of the GST-filter treats both spatial directions identically, by that being more appropriate to de-interlacing of video sequences.

The luminance value of a pixel within an image may be written as P(x, y, n). This pixel P situated at the position (x, y) in the n-th field may be interpolated using δₓ and δ_{y} as the horizontal and vertical sub-pixel fractions. The luminance value of a pixel may then be written as:

$$P ( x , y , n ) = \frac{1}{1 - \vert {δ}_{y} \vert} \{ \frac{{δ}_{y}}{2} ( 1 - \vert \frac{{δ}_{y}}{2} \vert ) {A}_{horiz} - \frac{{δ}_{y}}{2} ( 1 - \vert \frac{{δ}_{y}}{2} \vert ) {B}_{horiz} + {( 1 - \vert \frac{{δ}_{y}}{2} \vert )}^{2} {C}_{av} - {( \frac{{δ}_{y}}{2} )}^{2} {D}_{av} \} , \\ where$$

$${A}_{horiz} = {δ}_{x} ( 1 - \vert {δ}_{x} \vert ) A ( x - 1 , y + sign ( {δ}_{y} ) , n ) + ( {( {δ}_{x} )}^{2} + {( 1 - \vert {δ}_{x} \vert )}^{2} A ( x , y + sign ( {δ}_{y} ) , n ) + {δ}_{x} ( 1 - \vert {δ}_{x} \vert ) A ( x + 1 , y + sign ( {δ}_{y} ) , n ) \\ {B}_{horiz} = {δ}_{x} ( 1 - \vert {δ}_{x} \vert ) B ( x - 1 , y - sign ( {δ}_{y} ) , n ) + ( {( {δ}_{x} )}^{2} + {( 1 - \vert {δ}_{x} \vert )}^{2} ) B ( x , y - sign ( {δ}_{y} ) , n ) + {δ}_{x} ( 1 - \vert {δ}_{x} \vert ) B ( x + 1 , y - sign ( {δ}_{y} ) , n ) \\ and \\ {C}_{uv} = ( 1 - \vert {δ}_{x} \vert ) C ( x + {δ}_{x} , y + {δ}_{y} , n - 1 ) + \vert {δ}_{x} \vert C ( x + sign ( {δ}_{x} ) + {δ}_{x} , y + {δ}_{y} , n - 1 ) , \\ {D}_{uv} = ( 1 - \vert {δ}_{x} \vert ) D ( x + {δ}_{x} , y - 2 sign ( {δ}_{y} ) + {δ}_{y} , n - 1 ) + \vert {δ}_{x} \vert D ( x + sign ( {δ}_{x} ) + {δ}_{x} , y - 2 sign ( {δ}_{y} ) + {δ}_{y} , n - 1 )$$

give the horizontal aperture of the GST-filter. The values for A, B, C, D may be derived from neighbouring pixels, as depicted in FIG. 2.

FIG. 3 depicts 2-D regions of linearity, being bordered by bold lines. Pixels used in a non-separable GST filter are encircled.

From these equations, it can be seen that P(x,y,n) can be retrieved from a previous and the current field. However, it is also possible to interpolate a pixel with samples from the next (n+1)-field and the current n-field. Such a pixel calculated from a next sample can be written as

$$N ( x , y , n ) = \frac{1}{1 - \vert {δ}_{y} \vert} \{ \frac{{δ}_{y}}{2} ( 1 - \vert \frac{{δ}_{y}}{2} \vert ) {A}_{horiz} - \frac{{δ}_{y}}{2} ( 1 - \vert \frac{{δ}_{y}}{2} \vert ) {B}_{horiz} + {( 1 - \vert \frac{{δ}_{y}}{2} \vert )}^{2} {C}_{av} - {( \frac{{δ}_{y}}{2} )}^{2} {D}_{av} \} ,$$

with the specification that Cₐᵥ and Dₐᵥ are shifted from the next field,

$${C}_{av} = ( 1 - \vert {δ}_{x} \vert ) C ( x + {δ}_{x} , y + {δ}_{y} , n + 1 ) + \vert {δ}_{x} \vert C ( x + sign ( {δ}_{x} ) + {δ}_{x} , y + {δ}_{y} , n + 1 ) , \\ {D}_{av} = ( 1 - \vert {δ}_{x} \vert ) D ( x + {δ}_{x} , y - 2 sign ( {δ}_{y} ) + {δ}_{y} , n + 1 ) + \vert {δ}_{x} \vert D ( x + sign ( {δ}_{x} ) + {δ}_{x} , y - 2 sign ( {δ}_{y} ) + {δ}_{y} , n + 1 ) .$$

Assuming that the motion vector is linear over two field periods, a reliability of a video sequence, Rᵥ, of a motion vector with the corresponding vector fractions k and B for a given block of pixels may be calculated from

$${R}_{v} = {\sum }_{\hat{x}} \vert {N}_{{\vec{v}}_{N} = - {\hat{v}}_{P} = - \hat{v}} ( x , y , n ) - {P}_{{\vec{v}}_{P} = \vec{v}} ( x , y , n ) \vert$$

for all x̅ belonging to a 8×8 block of pixels.

However, in order to implement an inherently to film/video mode adapting de-interlacing, this reliability has to be checked for different vectors, e.g. for four possible situations which may occur in a sequence.

These different situations are v̅_{N}=− v̅_{P}, for video mode, v̅_{P}≠ 0̅ and v̅_{N}= 0̅, or v̅_{P}= 0̅ and v̅_{N}≠ 0̅ for two possible film modes, or v_{P}= 0̅ and v̅_{N}= 0̅ for zero mode.

FIG. 4a depicts a video mode, where v̅_{N}=− v̅_{P} As can be seen from FIG. 4a, v̅_{N}=− v̅_{P}, the two GST interpolated pixels 8 (P and N), using the motion compensated samples 6 from a previous field n−1 and from a next field n+1 shifted over a motion vector 4 resemble each other quite well. Thus, when de-interlacing such a sequence, video mode may be assumed.

From FIG. 4b, it may be seen that in film mode, the two GST interpolated pixels 8 (P and N), using the motion compensated samples 6 from the previous and the next field resemble most, in case v̅_{N}= 0̅ and v̅_{P} taken from an actual value.

The same applies for FIG. 4c, in which v̅_{P} equals zero, and v̅_{N} is estimated from an actual value.

In FIG. 4d a zero mode is depicted, where the motion compensated samples from the previous and the next field resemble most in case v̅_{N}= 0̅ and v̅_{P}= 0̅.

These different situations have to be taken into account when choosing the appropriate de-interlacing algorithm. Taken the situations into account, a reliability value may be calculated from

$$MIN \{ {R}_{v} = \vert {N}_{\vec{v} N = - \vec{v} ( x , y , n )} - {P}_{\vec{v} P = \vec{v} ( x , y , n )} \vert {R}_{f 1} = \vert {N}_{\vec{v} N = 0 ( x , y , n )} - {P}_{\vec{v} P = \vec{v} ( x , y , n )} \vert {R}_{f 2} = \vert {N}_{\vec{v} N = \vec{v} ( x , y , n )} - {P}_{\vec{v} P = 0 ( x , y , n )} \vert , {R}_{f 3} = \vert {N}_{\vec{v} N = 0 ( x , y , n )} - {P}_{\vec{v} P = 0 ( x , y , n )} \vert \} = minimum$$

for any pixel position (x,y) inside a 8×8 block of pixels.

By minimising this equation, the mode which seems to be most appropriate for the respective block may be calculated, and thus the motion vector estimation, which is used for de-interlacing the video, may be chosen.

In a refinement, the minimisation from the equation above may be added with a penalty given to the difference |N(x,y,n)−P(x,y,n)| by adding a positive value, if the mode which is tested through this difference is not the majority mode per image, or if it does not coincide with the mode of vectors in the direct neighbouring spatio-temporal environment.

By using an inherently adapting de-interlacing algorithm, as proposed, the possibility of interlacing hybrid video sequences is opened, for which none of the prior art algorithms are suitable. Such a method gives the possibility to perform properly the de-interlacing, independently of any additional information concerning the mode to which the sequence belongs. The inventive inherently adapting de-interlacing algorithm has the advantage that it may be optimised for the applied GST interpolation method, thus be robust with respect to this method.

1. Method for de-interlacing a hybrid video sequence using at least one estimated motion vector for interpolating pixels with the steps of:
defining pre-defined values for a first motion vector and a second motion vector,
calculating at least one first pixel using at least one pixel of a previous image and said first motion vector,
calculating at least one second pixel using at least one pixel of a next image and said second motion vector,
calculating a reliability of said first and said second motion vector by comparing at least said first pixel with at least said second pixel, said first and said second motion vectors being pre-defined for said calculation of reliability, and
estimating an actual value for a motion vector which turned out to be most reliable for de-interlacing said image.

2. Method of claim 1, wherein said pre-defined values for said motion vectors are related to each other.

3. Method of claim 1, wherein said pre-defined values for said motion vectors are inverted.

4. Method of claim 1, wherein one of said pre-defined values for said motion vectors has a value of zero and one of said pre-defined values for said motion vectors has an actual estimation value calculated from pixels of said previous and/or current and/or following image.

5. Method of claim 1, wherein the reliability of said motion vectors is calculated by calculating at least two error criteria, wherein for each of said error criteria different values for said pre-defined values for said motion vectors are chosen.

6. Method of claim 5, wherein said error criteria is calculated from an absolute sum over a block of pixels.

7. Method of claim 5, wherein said error criteria and/or said sum are modified according to an error criterion estimated to occur most frequently within at least parts of said image and/or the respective error criterion to be modified.

8. Method of claim 5, wherein said error criteria and/or said sum are modified depending on the error criteria calculated for temporally and/or spatially neighbouring blocks.

9. Display device for displaying a de-interlaced video signal comprising definition means for defining values for a first motion vector and a second motion vector,
first calculation means for calculating at least one first pixel using at least one pixel of a previous image and said first motion vector,
second calculation means for calculating at least one second pixel using at least one pixel of a next image and said second motion vector,
third calculation means for calculating a reliability of said first and said second motion vector by comparing at least said first pixel with at least said second pixel, said first and said second motion vectors being pre-defined for said calculation of reliability, and
estimation means for estimating an actual value for a motion vector which turned out to be most reliable for de-interlacing said image.

10. Computer programme for de-interlacing a video signal operable to cause a processor to
define values for a first motion vector and a second motion vector,
calculate at least one first pixel using at least one pixel of a previous image and said first motion vector,
calculate at least one second pixel using at least one pixel of a next image and said second motion vector,
calculate a reliability of said first and said second motion vector by comparing at least said first pixel with at least said second pixel, said first and said second motion-vectors being pre-defined for said calculation of reliability, and
estimate an actual value for a motion vector which turned out to be most reliable for de-interlacing said image.
